(19) United States
(12) Patent Application Publication
(10) Pub. No.: US 2026/0344591 A1
(43) Pub. Date: Nov. 5, 2026

(54) Irrigation Wheel Curtain

(71) Applicant: Isack Thiessen Wiebe, Dalhart, TX (US)

(72) Inventor: Isack Thiessen Wiebe, Dalhart, TX (US)

(21) Appl. No.: 19/186,456

(22) Filed: Apr. 22, 2025

(51) Int. Cl. A01G 25/09

(52) U.S. Cl. CPC A01G 25/09

(57) ABSTRACT

An irrigation wheel barrier system configured to protect a pair of wheels of a drive tower of a mechanized irrigation system from a water spray and thereby limiting harm to a tower track of is disclosed. Comprising the irrigation wheel barrier system comprises a barrier support frame attached to the drive tower and two barriers. The two barriers are configured for enclosing a portion of the pair of wheels of the drive tower and blocking a portion of the water spray from getting on or under the pair of wheels. The irrigation wheel barrier system is configured to connect to a portion of drive tower using barrier support frame. The irrigation wheel barrier system comprises a first barrier and a second barrier positioned to drape around the pair of wheels to prevent water spray from reaching the pair of wheels, thereby minimizing the formation of tower track.

### CROSS-REFERENCE TO RELATED APPLICATIONS

Not applicable.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

Modern mechanized irrigation systems are widely used in agricultural fields to ensure even and efficient distribution of water across large tracts of farmland. Typically, these systems comprise of drive towers mounted on wheels that support a series of water emitters, which provide irrigation to the crops below. However, a common issue with existing mechanized irrigation systems is the tendency for the wheels to become stuck due to water-induced soil disruption. As the irrigation system moves across a field, water spray from the emitters often reaches the wheels, creating muddy conditions that result in the formation of deep tracks, referred to as tower tracks. These tracks can lead to operational inefficiencies, requiring significant labor and time to address.

Existing solutions, such as increasing the wheel size or using specialized tires, have attempted to reduce the formation of tower tracks. However, these approaches often fall short in mitigating the root cause of the issue—excessive water reaching the wheels. When the wheels get wet, they lose traction, causing them to sink into the soil and form tracks that hinder the progress of the irrigation system. Additionally, raising the height of the sprinkler heads to prevent water from reaching the wheels can result in suboptimal irrigation coverage, impacting crop health and growth.

The present invention introduces an irrigation wheel barrier system designed to address the problem of wheel-soil interaction in wet conditions. By incorporating protective barriers that shield the wheels from direct water exposure, this system minimizes the formation of tower tracks while allowing efficient irrigation. The barrier system maintains the integrity of the soil under the wheels and enhances the overall efficiency of the mechanized irrigation system, reducing the maintenance requirements and improving irrigation performance. This invention aims to solve the limitations of prior systems by providing a more comprehensive and effective solution to mitigate the impact of water on the wheels, ultimately improving field conditions and reducing farmer workload.

Concerning the prior art, U.S. Pat. No. 10,492,384 B1 describes a mechanized irrigation system that employs a shield placed over the top of the wheels to prevent water from reaching the wheels and causing soil disruption. However, this design has several shortcomings. Firstly, the shield collects water on its top surface, which eventually runs off and accumulates under the wheels, leading to the same issue it was intended to prevent. Additionally, the design requires the sprinkler height to be raised to avoid water accumulating on the shield, which results in a reduction of the effective irrigation coverage area. This configuration leaves a gap around the wheels where crops cannot be effectively irrigated, reducing overall irrigation efficiency. The present invention addresses these issues by using barriers that prevent water from reaching the wheels altogether without altering the sprinkler height or creating areas of ineffective irrigation coverage.

### BRIEF SUMMARY OF THE INVENTION

An irrigation wheel barrier system 400 configured to protect a pair of wheels 106 of a drive tower 102 of a mechanized irrigation system 100 from a water spray 204 and thereby limiting harm to a tower track 110 of is disclosed. Comprising said irrigation wheel barrier system 400 comprises a barrier support frame 404 attached to said drive tower 102 and two barriers 402. said two barriers 402 are configured for enclosing a portion of said pair of wheels 106 of said drive tower 102 and blocking a portion of said water spray 204 from getting on or under said pair of wheels 106. said irrigation wheel barrier system 400 is configured to connect to a portion of drive tower 102 using barrier support frame 404. said irrigation wheel barrier system 400 comprises a first barrier 402a and a second barrier 402b positioned to drape around said pair of wheels 106 to prevent water spray 204 from reaching said pair of wheels 106, thereby minimizing the formation of tower track 110. said barrier support frame 404 further comprises a first horizontal member 700a, a second horizontal member 700b, a first attachment bracket 702a, a second attachment bracket 702b, a first spacer bracket 704a, a second spacer bracket 704b, a first riser member 706a, and a second riser member 706b. said first horizontal member 700a and said second horizontal member 700b extend laterally to provide structural stability. said first attachment bracket 702a and said second attachment bracket 702b are configured to attach said first horizontal member 700a and said second horizontal member 700b to a lower crossbar 104 of said drive tower 102. said first spacer bracket 704a and said second spacer bracket 704b are configured to maintain appropriate spacing between said first horizontal member 700a and said drive tower 102. said first riser member 706a and said second riser member 706b extend vertically to elevate and support said barrier support frame 404.

An irrigation wheel barrier system 400 configured to protect a pair of wheels 106 of a drive tower 102 of a mechanized irrigation system 100 from a water spray 204 and thereby limiting harm to a tower track 110 of is disclosed. Comprising said irrigation wheel barrier system 400 comprises a barrier support frame 404 attached to said drive tower 102 and two barriers 402. said two barriers 402 are configured for enclosing a portion of said pair of wheels 106 of said drive tower 102 and blocking a portion of said water spray 204 from getting on or under said pair of wheels 106. said irrigation wheel barrier system 400 is configured to connect to a portion of drive tower 102 using barrier support frame 404. said irrigation wheel barrier system 400 comprises a first barrier 402a and a second barrier 402b positioned to drape around said pair of wheels 106 to prevent water spray 204 from reaching said pair of wheels 106, thereby minimizing the formation of tower track 110.

A method for reducing wheel track formation in a mechanized irrigation system 100 is disclosed. Comprising positioning an irrigation wheel barrier system 400 around a pair of wheels 106 of a drive tower 102, securing said irrigation wheel barrier system 400 to a barrier support frame 404 attached to said drive tower 102, and emitting water spray 204 from a plurality of water emitters 120 to irrigate a crop 200. wherein said irrigation wheel barrier system 400 prevents said water spray 204 from reaching said pair of wheels 106, thereby reducing the formation of tower track 110.

### BRIEF DESCRIPTION OF THE SEVERAL VIEWS OF THE DRAWING

FIG. 1 illustrates a simplified overview of a mechanized irrigation system 100.

FIG. 2 illustrates an elevated top view of said mechanized irrigation system 100 with a crop 200.

FIG. 3 illustrates a perspective overview of said mechanized irrigation system 100.

FIGS. 4-6 illustrate three perspective overviews of drive tower 102 with an irrigation wheel barrier system 400.

FIG. 7 illustrates a perspective overview of said drive tower 102 with barrier support frame 404.

FIGS. 8A, 8B, 8C illustrates an elevated top view of said barrier support frame 404 with said drive tower 102, and an elevated top view of said barrier support frame 404 without said drive tower 102 and an elevated front view of said barrier support frame 404.

FIG. 9 illustrates an exploded view of said irrigation wheel barrier system 400 with a detailed view of the attachment and connection components.

FIGS. 10A, 10B, 10C illustrate an elevated top view and side view and end view of said barrier support frame 404.

FIG. 11 illustrates an elevated end view of said mechanized irrigation system 100 with said irrigation wheel barrier system 400 protecting pair of wheels 106 from water spray 204.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers'specific goals (e.g., compliance with system-and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

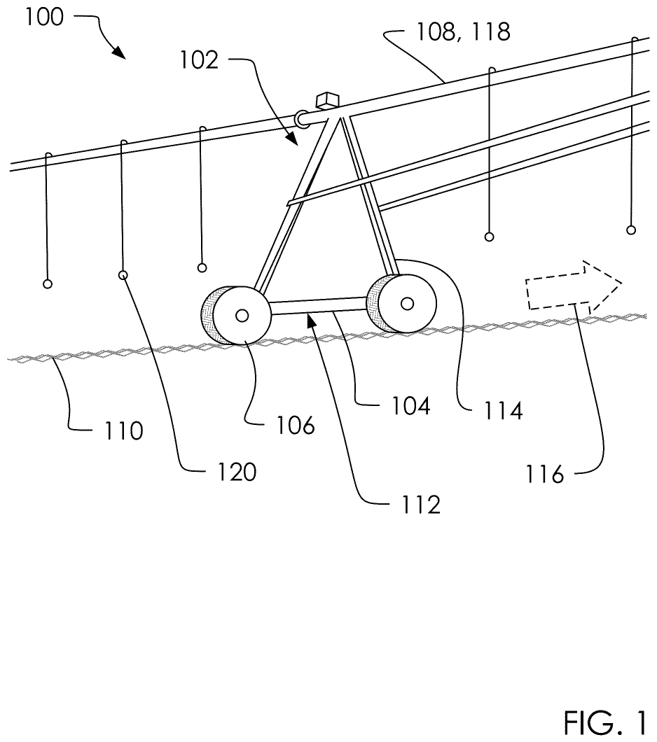

FIG. 1 illustrates a simplified overview of a mechanized irrigation system 100.

In one embodiment, said mechanized irrigation system 100 comprises a drive tower 102, which serves as the primary structural element supporting the system's components and maintaining its alignment as it moves across a field.

Said drive tower 102 is mounted on a pair of wheels 106, which facilitate the movement of said mechanized irrigation system 100 across a ground surface.

One difficulty with said mechanized irrigation system 100 is the formation of a tower track 110 along a path of said drive tower 102. One goal of the current disclosure is to ensure that said tower track 110 are minimized.

Said drive tower 102 can comprise a support frame 112 comprising a lower crossbar 104 and two vertical support members 114. In one embodiment, said pair of wheels 106 can be rotateably attached to said lower crossbar 104 and aligned with a direction of movement 116 of said drive tower 102.

Extending horizontally across said drive tower 102 is a span structure 118 comprising a water supply conduit 108, which acts as the conduit for delivering water from a central source to various outlets or emitters. Said water supply conduit 108 can include a plurality of water emitters 120 or sprinkler heads, allowing for even distribution of water as said mechanized irrigation system 100 advances across the field.

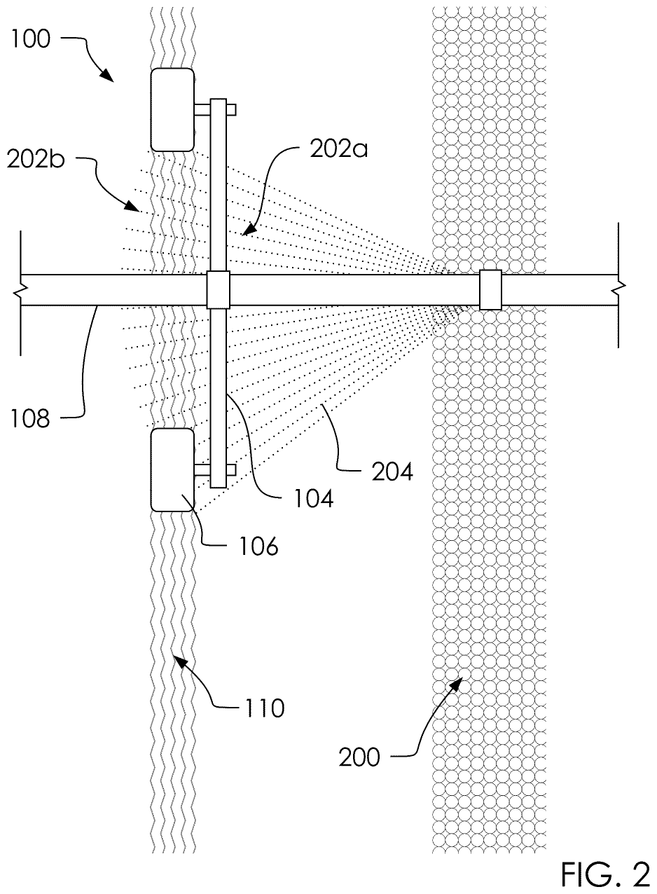

FIG. 2 illustrates an elevated top view of said mechanized irrigation system 100 with a crop 200.

In one embodiment, said drive tower 102 can comprise a first side 202a and a second side 202b.

In one embodiment, said mechanized irrigation system 100 can be used to irrigate said crop 200. Wherein, said crop 200 can be aligned with said tower track 110.

As illustrated, said plurality of water emitters 120 can emit a water spray 204 in a fixed pattern or rotating pattern. In many cases, said water spray 204 can spray water under said pair of wheels 106. Accordingly, said mechanized irrigation system 100 is poorly designed as it accelerates the destruction of said tower track 110.

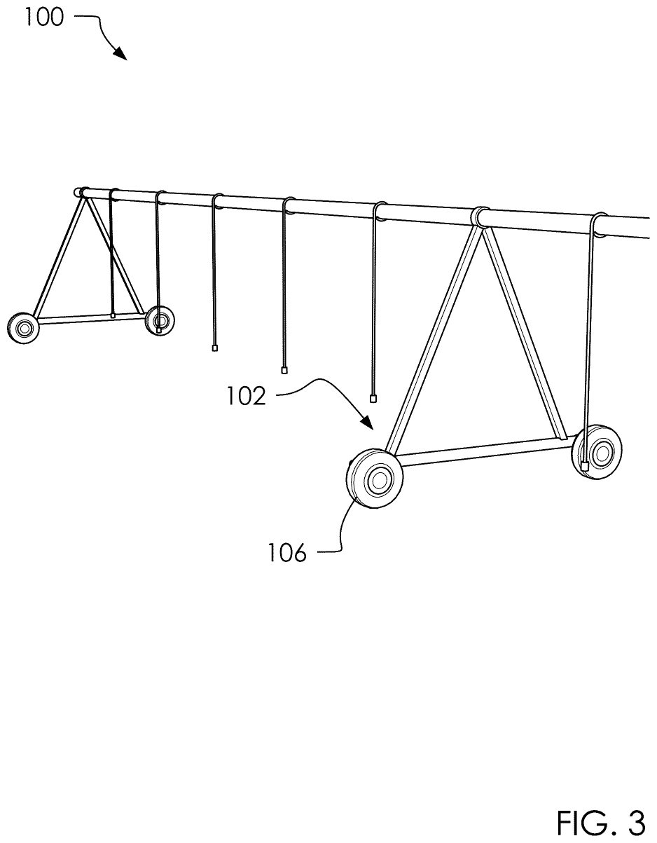

FIG. 3 illustrates a perspective overview of said mechanized irrigation system 100.

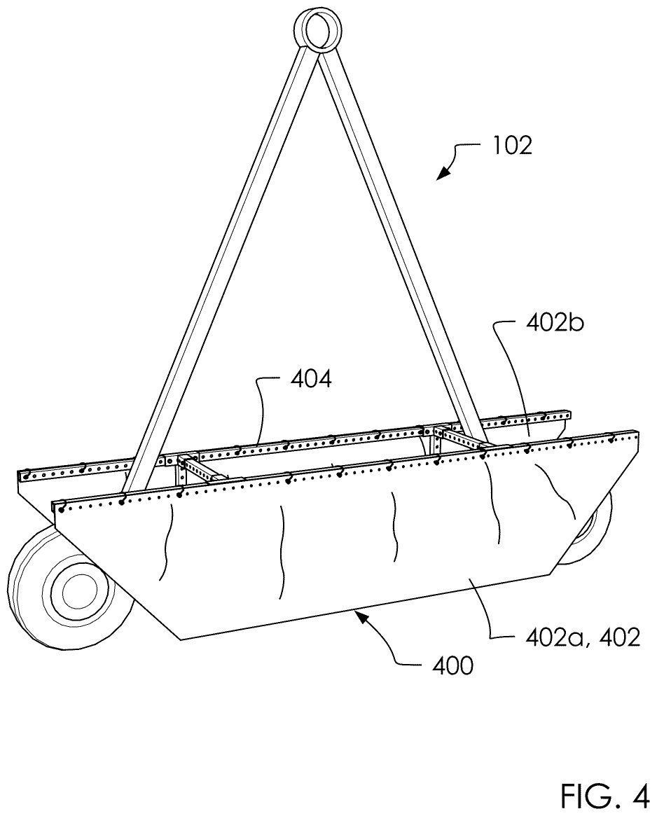

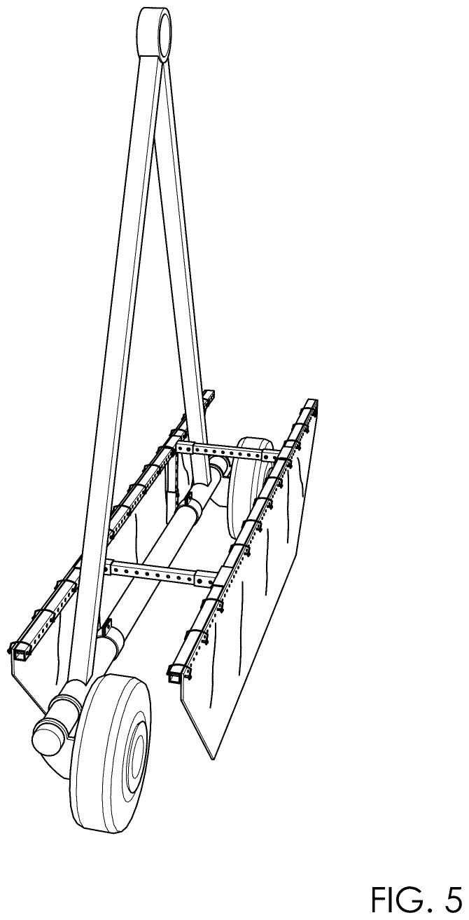

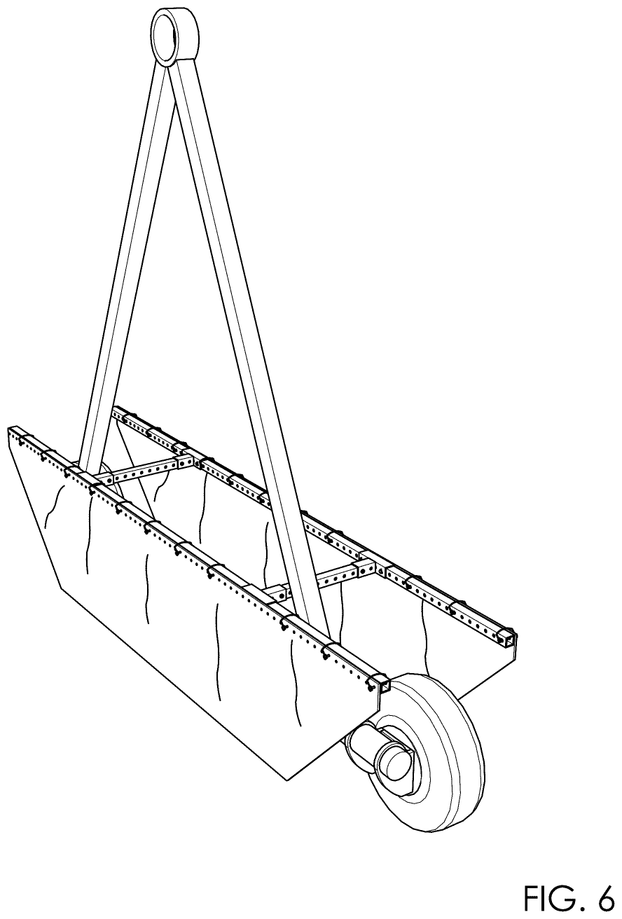

FIGS. 4-6 illustrate three perspective overviews of said drive tower 102 with an irrigation wheel barrier system 400.

In one embodiment, said irrigation wheel barrier system 400 can comprise two barriers 402 comprising a first barrier 402a and a second barrier 402b, and a barrier support frame 404.

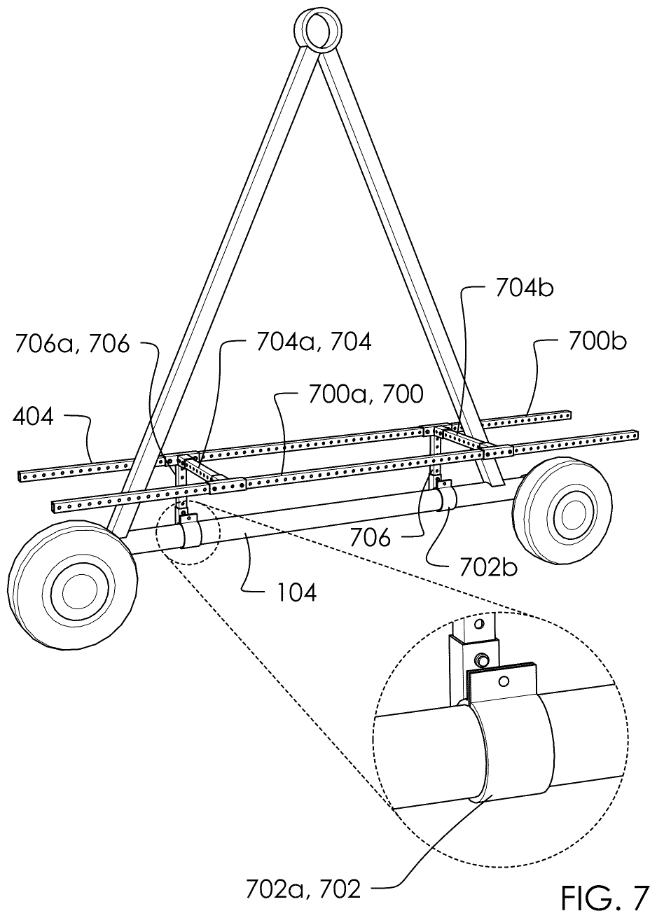

FIG. 7 illustrates a perspective overview of said drive tower 102 with said barrier support frame 404.

In one embodiment, said barrier support frame 404 can comprise one or more horizontal members 700, one or more attachment brackets 702, one or more spacer brackets 704, and one or more riser members 706, which include several key components. comprising several key components.

It is noted that barrier support frame 404 can be constructed of variations on the elements seen in the figures. For example, barrier support frame 404 can be constructed from round pipe.

The barrier support frame 404 of said irrigation wheel barrier system 400 can be constructed in various forms to accommodate different operational requirements and structural preferences. In one embodiment, said barrier support frame 404 is comprised of square tubing, as depicted in FIG. 7, which provides robust support and facilitates easy assembly due to its uniform geometry. Alternatively, said barrier support frame 404 may be constructed from welded tubing, which offers enhanced strength and rigidity for withstanding high operational loads and adverse environmental conditions.

In further embodiments, said barrier support frame 404 can incorporate other structural designs and materials. For instance, round tubing may be employed to reduce weight, allowing for easier maneuverability across fields while maintaining sufficient strength. Additionally, said barrier support frame 404 can be made from reinforced composite materials or other metals, enabling the frame to resist corrosion and reduce maintenance in areas with harsh weather or high moisture levels. This adaptability in frame construction allows said irrigation wheel barrier system 400 to cater to diverse agricultural needs, providing options for users based on cost, durability, and environmental considerations.

In one embodiment, said one or more horizontal members 700 include a first horizontal member 700a and a second horizontal member 700b, which extend laterally to provide structural stability. said one or more attachment brackets 702 include a first attachment bracket 702a and a second attachment bracket 702b. Said one or more spacer brackets 704 include a first spacer bracket 704a and a second spacer bracket 704b, configured to maintain appropriate spacing between said one or more horizontal members 700 and said drive tower 102. Said one or more riser members 706 comprise of a first riser member 706a and a second riser member 706b, which extend vertically to elevate and support the barrier support frame 404.

Said one or more attachment brackets 702 can be configured to securely attach said one or more horizontal members 700 to said lower crossbar 104 of said drive tower 102. Further, said one or more attachment brackets 702 are configured to arrange said one or more horizontal members 700 at said first side 202a and said second side 202b of said pair of wheels 106 of said drive tower 102 to drape said first barrier 402a and said second barrier 402b around said pair of wheels 106.

In one embodiment, two barriers 402 can comprise a tarp, plastic sheets, composite materials, or other suitable materials for blocking moisture and maintaining rigidity.

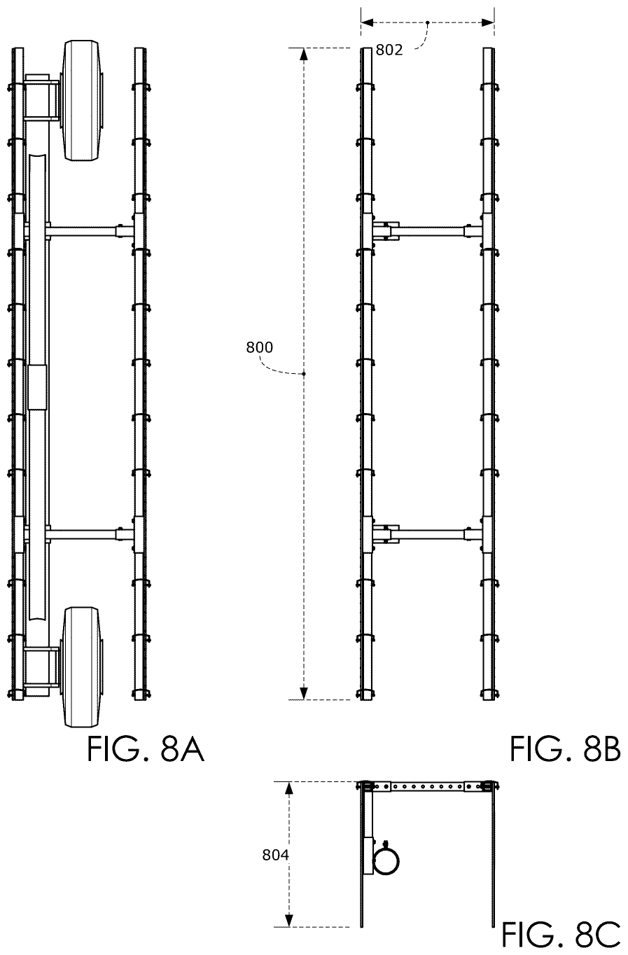

FIGS. 8A, 8B, 8C illustrates an elevated top view of said barrier support frame 404 with said drive tower 102, and an elevated top view of said barrier support frame 404 without said drive tower 102 and an elevated front view of said barrier support frame 404.

In one embodiment, said barrier support frame 404 can comprise frame length 800, frame width 802, and frame height 804, which define the overall dimensions of the support frame. The frame length 800 extends along the longitudinal axis of the frame, providing the necessary span for supporting the drive tower 102 and associated components. The frame width 802 defines the lateral distance across the frame, contributing to the stability and structural integrity of the system. The frame height 804 provides vertical clearance to accommodate other structural elements and to facilitate attachment to the drive tower 102.

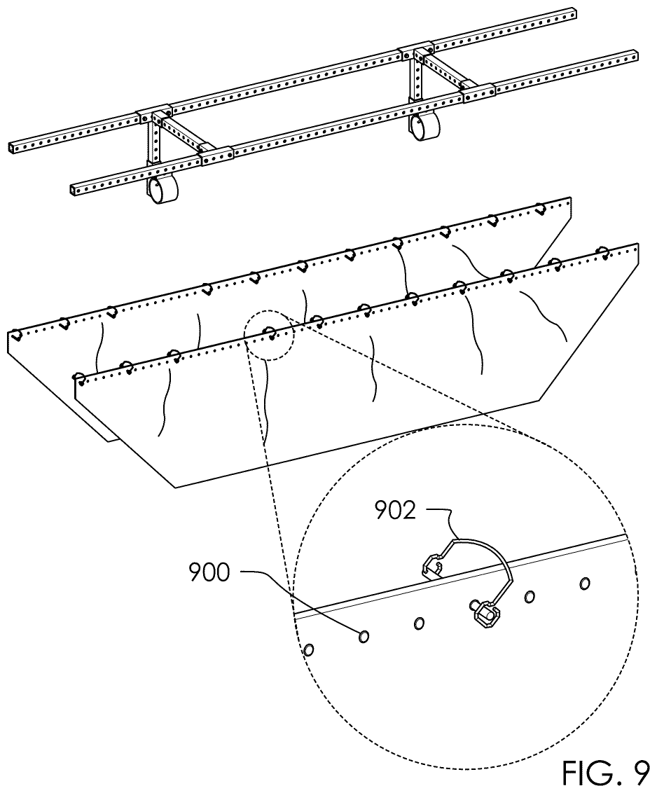

FIG. 9 illustrates an exploded view of the irrigation wheel barrier system 400 with a detailed view of the attachment and connection components.

In one embodiment, a plurality of eyelets 900 are located along the top edge of the barrier sheet and runs from one end of the barrier to the other along its length. These apertures allow for the attachment of the barrier to the support frame.

While other configurations are possible, the current embodiment shows the apertures being utilized for a secure attachment.

An enlarged detail of attachment mechanism 902 is also shown, which interacts with said plurality of eyelets 900. The attachment mechanism comprises of fasteners or clips, which allow for easy installation and removal of the barrier. These mechanisms ensure that each of said two barriers 402 stays in place during irrigation operations, thereby minimizing contact between the wheels and surrounding soil.

This exploded view clarifies how the barrier system is assembled and highlights the use of apertures and fasteners to secure the barrier effectively, reducing soil disruption and enhancing the efficiency of the irrigation system.

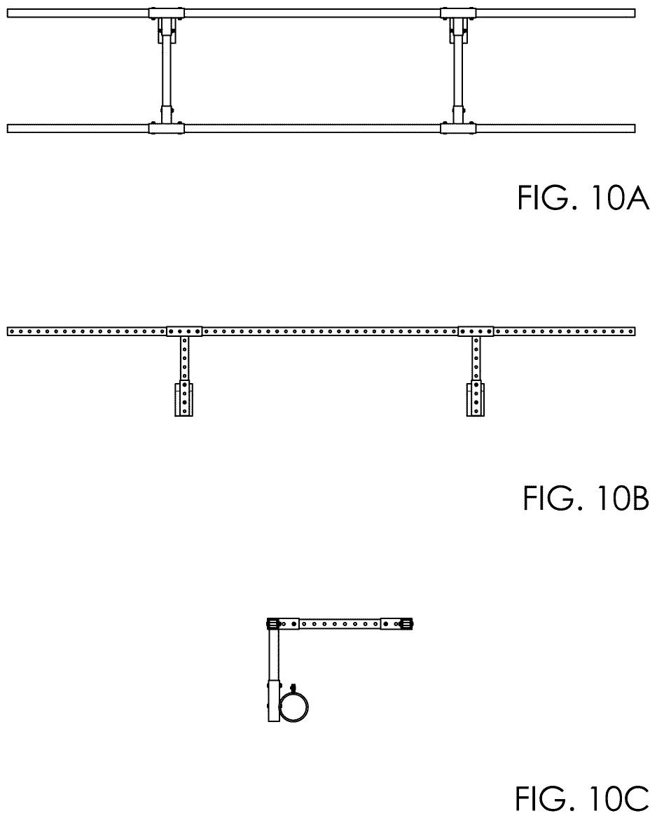

FIGS. 10A, 10B, 10C illustrate an elevated top view and side view and end view of said barrier support frame 404.

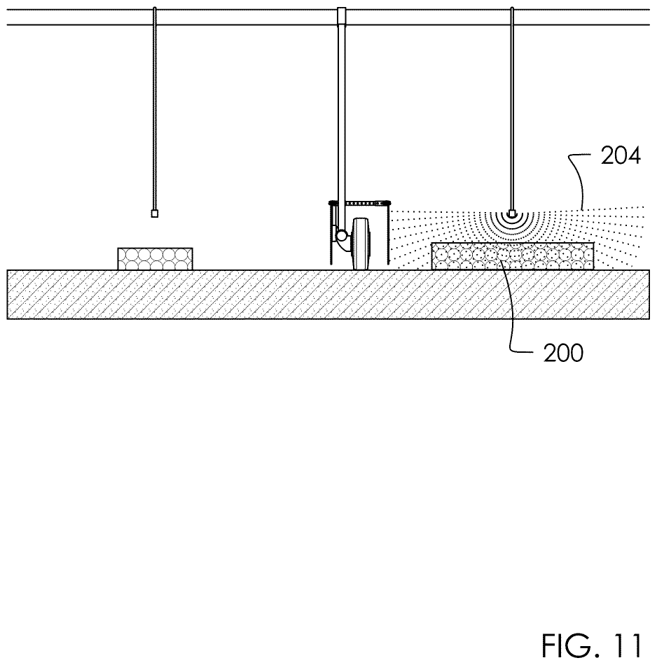

FIG. 11 illustrates an elevated end view of said mechanized irrigation system 100 with said irrigation wheel barrier system 400 protecting said pair of wheels 106 from said water spray 204.

In this configuration, the irrigation wheel barrier system 400 effectively prevents said water spray 204 from reaching the pair of wheels 106 as the system advances across a field. The figure shows how said water spray 204 is directed towards said crop 200 while the barriers ensure that the wheels are shielded from both direct water contact and soil erosion effects.

The water spray 204, emitted by said plurality of water emitters 120, ensures uniform irrigation of said crop 200. However, without the use of the irrigation wheel barrier system 400, the pair of wheels 106 would be exposed to excessive water, which could lead to the formation of said tower track 110. By utilizing said first barrier 402a and said second barrier 402b, said mechanized irrigation system 100 maintains operational efficiency and reduces maintenance needs by keeping the wheels clear from excess moisture and minimizing soil disruption.

### PARTS LIST

mechanized irrigation system 100,
drive tower 102,
lower crossbar 104,
pair of wheels 106,
water supply conduit 108,
tower track 110,
support frame 112,
two vertical support members 114,
direction of movement 116,
span structure 118,
plurality of water emitters 120,
crop 200,
second side 202b,
first side 202a,
water spray 204,
irrigation wheel barrier system 400,
second barrier 402b,
first barrier 402a,
two barriers 402,
barrier support frame 404,
second horizontal member 700b,
first horizontal member 700a,
one or more horizontal members 700,
second attachment bracket 702b,
first attachment bracket 702a,
one or more attachment brackets 702,
first spacer bracket 704a,
second spacer bracket 704b,
one or more spacer brackets 704,
second riser member 706b,
first riser member 706a,
one or more riser members 706,
frame length 800,
frame width 802,
frame height 804,
plurality of eyelets 900, and
attachment mechanism 902.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An irrigation wheel barrier system configured to protect a pair of wheels of a drive tower of a mechanized irrigation system from a water spray and thereby limiting harm to a tower track of comprising:
said irrigation wheel barrier system comprises a barrier support frame attached to said drive tower and two barriers;
said two barriers are configured for enclosing a portion of said pair of wheels of said drive tower and blocking a portion of said water spray from getting on or under said pair of wheels;
said irrigation wheel barrier system is configured to connect to a portion of said drive tower using said barrier support frame;
said irrigation wheel barrier system comprises a first barrier and a second barrier positioned to drape around said pair of wheels to prevent said water spray from reaching said pair of wheels, thereby minimizing the formation of said tower track;
said barrier support frame further comprises a first horizontal member, a second horizontal member, a first attachment bracket, a second attachment bracket, a first spacer bracket, a second spacer bracket, a first riser member, and a second riser member;
said first horizontal member and said second horizontal member extend laterally to provide structural stability;
said first attachment bracket and said second attachment bracket are configured to attach said first horizontal member and said second horizontal member to a lower crossbar of said drive tower;
said first spacer bracket and said second spacer bracket are configured to maintain appropriate spacing between said first horizontal member and said drive tower; and
said first riser member and said second riser member extend vertically to elevate and support said barrier support frame.

2. The mechanized irrigation system of claim 1, wherein each of said two barriers comprise a plurality of eyelets along a top edge;
said irrigation wheel barrier system further comprises a plurality of an attachment mechanism; and
said attachment mechanism are configured to engage with said plurality of eyelets for securing said irrigation wheel barrier system to said barrier support frame.

3. The mechanized irrigation system of claim 1, wherein
said irrigation wheel barrier system is configured to shield said pair of wheels without altering the height of a plurality of water emitters.

4. The mechanized irrigation system of claim 1, wherein
said one or more attachment brackets is configured to securely attach said one or more horizontal members to said lower crossbar of said drive tower;
said one or more attachment brackets are configured to arrange said one or more horizontal members at said first side and said second side of said pair of wheels of said drive tower to drape said first barrier and said second barrier around said pair of wheels.

5. The mechanized irrigation system of claim 1, wherein
the water spray, emitted by said plurality of water emitters, ensures uniform irrigation of crop; and
said irrigation wheel barrier system is configured to maintain operational efficiency of said mechanized irrigation system and reduces maintenance needs by keeping the wheels clear from excess moisture and minimizing soil disruption.

6. An irrigation wheel barrier system configured to protect a pair of wheels of a drive tower of a mechanized irrigation system from a water spray and thereby limiting harm to a tower track of comprising:
said irrigation wheel barrier system comprises a barrier support frame attached to said drive tower and two barriers;
said two barriers are configured for enclosing a portion of said pair of wheels of said drive tower and blocking a portion of said water spray from getting on or under said pair of wheels;
said irrigation wheel barrier system is configured to connect to a portion of said drive tower using said barrier support frame; and
said irrigation wheel barrier system comprises a first barrier and a second barrier positioned to drape around said pair of wheels to prevent said water spray from reaching said pair of wheels, thereby minimizing the formation of said tower track.

7. The mechanized irrigation system of claim 6, wherein each of said two barriers comprise a plurality of eyelets along a top edge;
said irrigation wheel barrier system further comprises a plurality of an attachment mechanism; and
said attachment mechanism are configured to engage with said plurality of eyelets for securing said irrigation wheel barrier system to said barrier support frame.

8. The mechanized irrigation system of claim 6, wherein said irrigation wheel barrier system is configured to shield said pair of wheels without altering the height of a plurality of water emitters.

9. The mechanized irrigation system of claim 6, wherein
said barrier support frame further comprises a first horizontal member, a second horizontal member, a first attachment bracket, a second attachment bracket, a first spacer bracket, a second spacer bracket, a first riser member, and a second riser member;
said first horizontal member and said second horizontal member extend laterally to provide structural stability;
said first attachment bracket and said second attachment bracket are configured to attach said first horizontal member and said second horizontal member to a lower crossbar of said drive tower;
said first spacer bracket and said second spacer bracket are configured to maintain appropriate spacing between said first horizontal member and said drive tower; and
said first riser member and said second riser member extend vertically to elevate and support said barrier support frame.

10. The mechanized irrigation system of claim 6, wherein
said one or more attachment brackets is configured to securely attach said one or more horizontal members to said lower crossbar of said drive tower;
said one or more attachment brackets are configured to arrange said one or more horizontal members at said first side and said second side of said pair of wheels of said drive tower to drape said first barrier and said second barrier around said pair of wheels.

11. The mechanized irrigation system of claim 6, wherein
the water spray, emitted by said plurality of water emitters, ensures uniform irrigation of crop; and
said irrigation wheel barrier system is configured to maintain operational efficiency of said mechanized irrigation system and reduces maintenance needs by keeping the wheels clear from excess moisture and minimizing soil disruption.

12. A method for reducing wheel track formation in a mechanized irrigation system, comprising:
positioning an irrigation wheel barrier system around a pair of wheels of a drive tower, securing said irrigation wheel barrier system to a barrier support frame attached to said drive tower, and
emitting water spray from a plurality of water emitters to irrigate a crop; wherein said irrigation wheel barrier system prevents said water spray from reaching said pair of wheels, thereby reducing the formation of tower track.
